(19) United States
(12) Patent Application Publication
(10) Pub. No.: US 2008/0030419 A1
(43) Pub. Date: Feb. 7, 2008

(54) Antenna Device

(75) Inventor: Peter Sjöblom, Lund (SE)

Correspondence Address: BACHMAN & LAPOINTE, P.C., 900 CHAPEL STREET, SUITE 1201, NEW HAVEN, CT, 06510, US

(73) Assignee: PERLOS TECHNOLOGY OY, Vantaa (FI)

(21) Appl. No.: 10/594,179

(22) PCT Filed: Mar. 24, 2005
(86) PCT No.: PCT/SE05/00447

§ 371 Date: Sep. 22, 2006

(30) Foreign Application Priority Data
Mar. 26, 2004 (SE) 0400801-7

(51) Int. Cl. H01Q 1/50; H01Q 21/00

(52) U.S. Cl. 343/853

(57) ABSTRACT

An antenna device for a mobile phone designed for operation in full duplex comprises a transceiver unit (1) having one transmitting subunit (2) and one receiving subunit (3). At least one first antenna (6) is connected to the transmitting subunit (2) via an active matching network (5). At least a second antenna (8), separate and discrete from the first antenna (6), is connected to the receiving subunit (3). In one embodiment there is also an active matching network (11) between the second antenna (8) and the receiving subunit (3). Both the first and the second antennas may comprise more than one radiating element.

### TECHNICAL FIELD

The present invention relates to an antenna device for a radiocommunications apparatus, for example a cell or mobile telephone, designed for operation in full duplex, comprising: a transceiver unit and means for radiating and receiving radio waves, such means including an active matching network.

### BACKGROUND ART

The totally dominant concept as regards antennas for mobile telephones entails the employment of a single antenna with a single feed. Even if this antenna may, at a casual glance, have the appearance of several antennas employed in parallel, this is not the case. There is only a single feed up to this antenna, but this has a number of branches of different lengths for different frequency bands. In addition to such a main antenna, parasite elements may also occur which improve radiation. These parasite elements may either be “freely floating” or be grounded.

Cell or mobile telephones are previously known in the art which operate in full duplex, so-called 3G telephones. They normally have one antenna with feeding emanating from a central radio unit.

Cell or mobile telephones are also previously known in the art which may operate in both the 2G system and in the 3G system. These telephones normally employ an embedded antenna for the 2G system and a single external antenna for the 3G system.

A factor that has been given increasing importance in the design and construction of mobile telephones is the operational time possible between charging of the battery of the mobile telephone. In a mobile telephone, it is the transmitter circuits that consume considerable power. In order that the range of the mobile telephone be sufficient, a minimum power output must be radiated from the antenna of the mobile telephone. How large this radiated power output will be depends naturally on how great the power is that is fed into the transmitter circuits, their degree of efficiency, but also to a large extent on the degree of efficiency of the antenna or the antenna system. The losses that occur in total consist, to a large extent, of losses caused by poor matching between the antenna and the transmitter circuits.

Those components, in the transmitter circuits, which are located most proximal the antenna are optimised for 50 ohms impedance. In order to obtain as good efficiency in the antenna as possible, this should also show 50 ohms impedance against the transmitter circuits. This becomes complicated when it is expected that the antenna will be able to operate in a plurality of mutually discrete and separate frequency bands and when, in addition, the space available for the antenna is shrinking.

The problem is not limited to reduced transfer of power in case of mismatch, but the power reflected back to the radio module is creating a long range of problems disturbing the radio functionality.

In order to match the antenna to the transmitter circuits, use is made of matching networks which contain inductances and capacitances. In the design and construction of a matching network, a consideration must be made between matching performance and bandwidth. A matching network which shows superior matching is consequently limited to a very narrow frequency band. By the employment of different matching networks, each matching network can cover a narrow frequency band so that the total coverage will be sufficient. Alternatively, switching may be put into effect internally in the matching network so that, by engagement or disengagement of components, this may cover in a larger frequency range. However, in each setting of an adaptive matching network, if the matching is good, the frequency range is very narrow.

A radiocommunications apparatus which operates in full duplex has the capability of both transmitting and receiving simultaneously. According to a standard, WCDMA (Wideband Code Division Multiple Access), this is attained in that, within each frequency band, transmission and reception take place at different frequencies. The above-mentioned standard entails that the gap between transmission frequency and reception frequency, called the duplexer distance, is 190 MHz. In each setting position, the adaptive matching network handles only a frequency range of the order of magnitude of 30 MHz. This implies that, if the matching network is set for optimum performance at transmission frequency, where the demand for a high degree of efficiency is greatest, the antenna will, on receiving, suffer from considerable defective matching.

Unfortunately the gap is also too narrow to enable the possibility to match the transmitter, Tx, and receiver, Rx, independently. For that purpose a distance larger than 700 MHz is needed, like the distance between the GSM900 and GSM1800 bands (GSM=Global System for Mobile communication).

### PROBLEM STRUCTURE

The present invention has for its object to design the antenna device intimated by way of introduction so that the drawbacks inherent in prior art technology are obviated. In particular, the present invention has for its object to design the antenna device so that it permits simultaneous transmission and reception while retaining a high degree of efficiency both in transmission and in reception.

### SOLUTION

The objects forming the basis of the present invention will be attained if the antenna device intimated by way of introduction is characterised in that the means for radiating and receiving radio waves includes at least a first antenna element which, via the active matching network, is connected to the transmitter subunit of the transceiver unit, and at least a second antenna element, separate and discrete from the first, which is connected to the receiver subunit of the transceiver unit.

Through these characteristics the following advantages are attained: The solution of separating the radiators for the transmitter, Tx, and the receiver, Rx, has several benefits. The isolation is improved when the radiators are separated. Instead of creating one diplexer filter for one feeding transmission line to the antenna, two transmission lines could be used and instead two bandpass filters with better characteristics can be created. There is a possibility to utilize previously unused space when one big radiator is separated into several smaller radiators. For example one radiator could be at the top of the phone and the other at the bottom

### BRIEF DESCRIPTION OF THE ACCOMPANYING DRAWINGS

The present invention will now be described in greater detail herein below, with reference to the accompanying drawings. In the accompanying drawings:

FIG. 1 is a schematic diagram of the device according to the invention;

FIG. 2 is a diagram according to FIG. 1 of an alternative embodiment of the invention; and

FIG. 3 is a diagram according to FIGS. 1 and 2 of yet another embodiment of the invention.

### DESCRIPTION OF PREFERRED EMBODIMENT

In this text the case of a traditional base station and a traditional mobile phone will be used to describe the invention. As the progress of consumer electronics is making the difference between a phone, a small handheld computer, or a card inserted in a portable or stationary computer unclear, it should be understood that the invention is not limited to only one of those cases.

In the accompanying Drawing, reference numeral 1 relates to a radio unit which has a transmitter subunit 2 and a receiver subunit 3. From the transmitter subunit 2, a first feeding line 4 extends to an active or adaptive matching network 5. The matching network 5 is connected to a first antenna element 6 which is thus designed so as to radiate the energy that the transmitter subunit 2 produces.

The receiver subunit 3 in the radio unit 1 is connected via a second feeding line 7 to a second antenna element 8. Both the second feeding line 7 and the second antenna element 8 are separate and discrete from the first feeding line 4 and the first antenna element 6.

The matching network 5 may be of L-type, T-type or [symbol] -type, or a combination thereof. The matching network 5 includes a number of inductances and capacitances which can be mutually reswitched so that the matching network can, with great accuracy, match the antenna element 6 to the transmitter circuits in the transmitter subunit 2.

The matching network 5 has a control input 12, via which the switching of the different components of the matching network is controlled. The control input 12 is also in communication with circuits in the mobile telephone from which information can be retrieved as to in what frequency band transmission is to be carried out.

The matching network 5 contains, in a preferred embodiment, a microprocessor with software that configures the inductances and capacitors for optimum matching of the antenna to the Rx and Tx circuits. The control input 12 from the mobile phone electronics supplies the matching network with necessary control information regarding operational status, such as frequency and type of communication (e.g. GSM, GSM1800, GSM1900 or WCDMA) and environmental status. Information on how the environment affects the received and transmitted signals can be received from the mobile phone electronics through e.g.: RSSI (Receiver Signal Strength Indicator), the transmitter's VSWR (Voltage Standing Wave Ratio), BER (Bit Error Rate) or C/N, signal/noise ratio.

The first antenna element 6 may be a single antenna which, by suitable matching via the matching network, may be brought to resonance at a plurality of different frequencies.

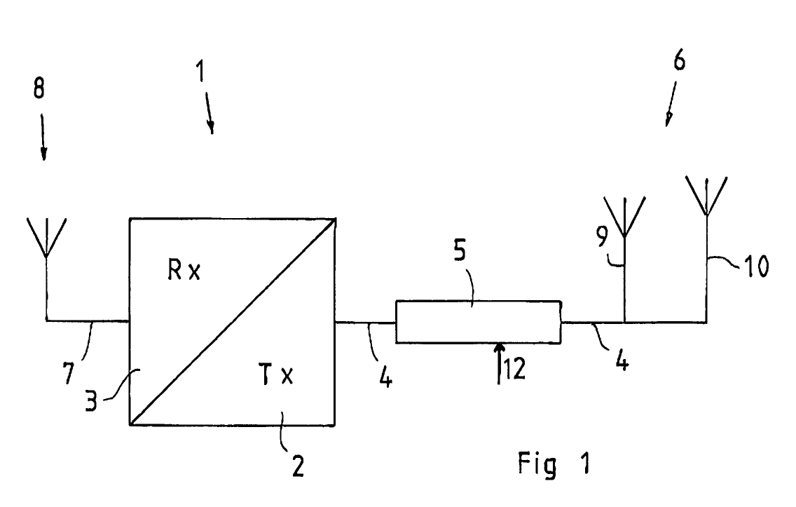

FIG. 1 shows one alternative where the first antenna element 6 has two different radiators of different lengths. In such instance, use is made of the shorter radiator 9 at higher frequencies while the longer radiator 10 is brought to resonance at lower frequencies.

The first antenna element 6 may however also be designed in such a manner that it is composed of a plurality of different radiator elements, which are mutually interconnectable and interconnectable to the matching network in a number of alternative combinations.

By the optimisation of the transmission function which is attained with the aid of the matching network 5, a high degree of efficiency will be achieved within a narrow frequency range. If the receive function were also to pass via the first antenna element 6, this would entail that the reception function would be extremely poor, since the matching network 5 “has focussed on” a frequency that lies at 190 MHz distance from the reception frequency. By the employment of the second, separate antenna element 8 and the associated separate feeding line 7, this problem is avoided, for which reason the reception function is also put into effect with a high degree of efficiency.

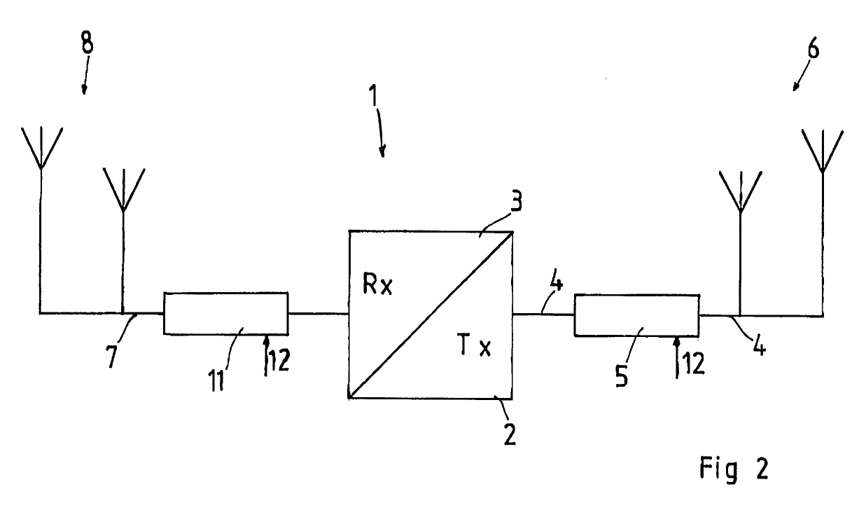

As an alternative to the above-described embodiment, it might be mentioned that it is also possible to use, between the second antenna element 8 and the receiver subunit 3, an active or adaptive matching network 11 as illustrated in FIG. 2. In such an event, this is separate and discrete from the first adaptive matching network.

The second antenna element 8 can also include two or more radiator elements as described for the first antenna element 6. Also, there is a control input 12 to the matching network 11.

In order that mutual interference between the first and the second antenna elements 6 and 8, respectively, is to be as slight as possible, it may be appropriate, for example, to place the first antenna element on the upper region of the mobile telephone, while the second antenna element 8 is placed on its lower region. Otherwise expressed, it is appropriate to place the two antenna elements at as great mutual spacing from each other as possible.

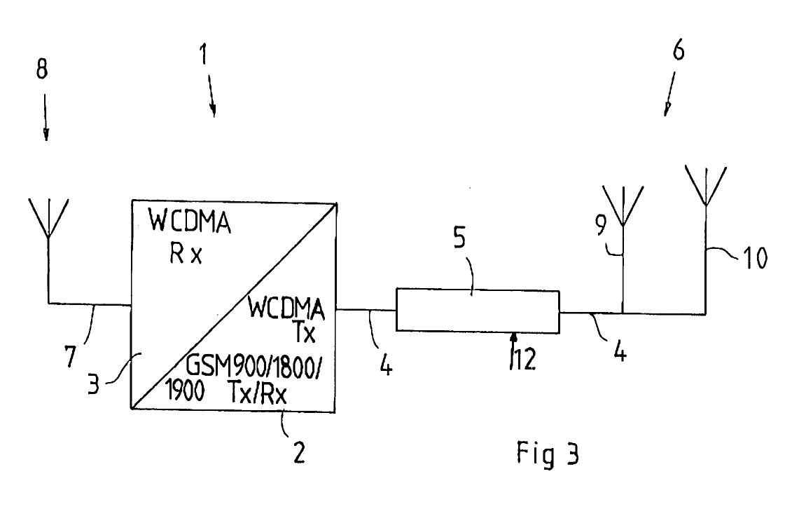

FIG. 3 shows another embodiment of the invention, illustrating one of many examples of how the invention can be implemented. A phone 1 supports GSM900, GSM1800, GSM1900 and WCDMA. For an overview of their respective frequency allocations see Table 1.

TABLE 1

| Name | Tx (MHz) | Rx (MHz) |
|---|---|---|
| GSM900 | 880-915 | 925-960 |
| GSM1800 | 1710-1785 | 1805-1880 |
| GSM1900 | 1850-1910 | 1930-1990 |
| WCDMA | 1920-1980 | 2110-2170 |

As can be seen in table 1, the Tx part of WCDMA is located where GSM1900 is located. An ordinary antenna radiator 6 covering GSM900/GSM1800/GSM1900 will hence automatically cover the Tx part of WCDMA. With an adaptive matching 5 added, this antenna 6 will cover these bands well, and a supplemental radiator 8 located elsewhere can support Rx for WCDMA. The adaptive matching 5 can now be used not only for Tx for WCDMA but also for GSM900, GSM1800 and GSM1900. One location for this adaptive matching 5 is in the diplexer module. This module can be constructed within a ceramic substrate where also the components for the adaptive matching 5 could be created. On top of the substrate mounted by flip-chip technology a steering circuit created in CMOS, LDMOS and possible using MEMS switches could be mounted.

In this description it has been shown how the invention can be implemented with the WCDMA system. Of course the skilled person will realise that it can be implemented on any duplex system.

As an alternative to or an improvement of the matching networks 5 described above there will be described below an antenna tuning unit.

Antenna matching is improved with adaptive matching based on switched shunt capacitors arranged in capacitor banks and external series inductors. There is a 1 dB power loss for a perfect 50 Ω→50 Ω transformation, a break-even point at VSWR=1.5, and a 3 dB increase in delivered power for VSWR=4.3.

I. Introduction

The adaptive matching network is inserted between the antenna and the first/last stage of the radio, typically a PA or LNA. Sometimes a filter precedes the PA or LNA. The complete adaptive matching network is by itself a combination of standard and novel building blocks.

The main concept is that a matching network care (in FIG. 4 indicated as a box with a Ω-sign and an arrow) is controlled with signals from either the baseband or a detector. The baseband signal will typically be used in the case of a receiver where BER value, S/N value and other parameters are accessible. The power detector here illustrated by a sample and hold circuit will typically be used when high powers are used, as the case when transmitting. A controller system can then switch the network through all possible combinations and arrive at a state that yields the best performance.

As the network care, a configuration with switched capacitor banks and fixed inductors are used. FIG. 5 shows an example of this topology. The load will typically be an antenna. The switch is a transistor, which is controlled by the gate voltage. It can either be ON where it is conducting or OFF where it is not conducting.

To gain enough latitude to match a wide range of impedances, a single inductor will not suffice. One solution has two inductors and three capacitor banks, network 1, arranged as in FIG. 5. As an alternative, one can design a solution suitable for bond wires. It consists of the two inductors created by bond wires and one additional inductor in the centre. Two capacitor banks are placed between the three inductors. This network, network 2, has same performance as network 1.

II. The Switch and the Capacitor

The two most important factors for the switch and the capacitor being switched are the quality factor, Q, in the ON state and the capacitance difference between the ON and OFF stages, i.e., the tuning range. Since no DC current flows through the capacitor, the transistor is in the triode region. In the ON stage, the transistor behaves as a drain-source series resistance, r_{ds0}. Since Q is given by

$$\begin{matrix}Q = \frac{1}{2 π {fCr}_{ds}} & ( 1 ) \\ where & \\ {r}_{ds 0} = \frac{1}{{g}_{ds 0}} {g}_{ds 0} = μ {C}_{ox} \frac{w}{l} ( {V}_{gs} - {V}_{t} ) & ( 2 )\end{matrix}$$

it is clear that Q is increased for wide and short transistors driven at a high gate voltage. For best performance, the length selected should be as short as possible and the gate voltage as high as possible. The width, however, will be used as a trade-off between Q and tuning range.

In the OFF state, r_{ds} is very large and has no influence on the impedance. Instead, the drain-bulk and drain-gate capacitances, which may be neglected in the ON state, predominate. When the switch is OFF, a series connection is formed with the switched C and the drain capacitance, C_{d}. Since drain capacitance is proportional to the width of the transistor, a wide transistor increases Q, but also increases the OFF capacitance—which in turn decreases the tuning range. This leads to a compromise, as shown in FIG. 3, where Q and tuning range (C_{ON}/C_{OFF}) are plotted as functions of the transistor width.

III. Matching Theory

The highest and the lowest capacitance a bank can provide create a capacitance window where the tuning range can be defined as

$$r = \frac{{C}_{max}}{{C}_{min}} \qquad ( 3 )$$

where r is the tuning range, Cₘₐₓ is the capacitance maximum, and Cₘᵢₙ is the capacitance minimum. Within this window, a number of capacitance values will be located. The number depends on the number of switches in the bank. By binary weighting, the capacitances that can be created will be evenly distributed. The smallest capacitor value that should be placed in the bank can be calculated from

$${\sum }_{n = 0}^{N - 1} {a}^{n} {C}_{ON} = {C}_{max} \\ {\sum }_{n = 0}^{N - 1} {a}^{n} \frac{{C}_{ON}}{r} = {\sum }_{n = 0}^{N} {a}^{n} {C}_{OFF} - {C}_{min} \qquad ( 4 )$$

where N is the number of switches in the bank, is the weight (=2 in the case of binary weighting), and CON is the smallest value of the capacitances in the bank. The other capacitances would then be C_{ON}, ²C_{ON}, etc.

With 8 switches 2⁸=256 different states are created with a unique impedance transformation of the load impedance. Together they create a matching domain. If the capacitances could be continuously tuned between Cₘᵢₙ and Cₘₐₓ, all the impedance points within the matching domain would be reachable. A matching domain is plotted in FIG. 7.

The difference between power delivered to a matched and an unmatched load can be plotted as an improvement, as has been done in FIG. 8. Several key figures can be identified. The 50 Ω→50 Ω transformation is significant since it indicates the losses in the network if a perfect match is assumed. The ideal power in the load here drops to about 0.8 or by 1 dB. Sacrificing 1 dB, even though the load is perfectly matched without the network, is often acceptable. The antenna is seldom perfectly matched because this can only be done for a narrow band. The point where improvement created by better matching equals losses should be reached for the smallest possible VSWR. Here it is attained at VSWR=1.5, a value better than what antennas usually have. In practice, one can therefore expect an improved output power using network 1 or 2. Also of importance is the 3 dB increase point, where power delivered to the load is twice what it would have been without matching. For the networks, the 3 dB point is located at VSWR=4.3.

What is claimed is:

1. An antenna device for a radiocommunications apparatus, for example a cell or mobile telephone, designed for operation in full duplex, comprising: a transceiver unit (1) and means for radiating and receiving radio waves, said means including an active matching network (5), characterised in that said means for radiating and receiving radio waves includes at least a first antenna element (6) which, via the active matching network (5), is connected to the transmitter subunit (2) of the transceiver unit (1), and at least a second antenna element (8), separate and discrete from the first, which is connected to the receiver subunit (3) of the transceiver unit (1).

2. The antenna device as claimed in claim 1, characterised in that said means for radiating and receiving radio waves includes two or more antenna elements (9, 10) connected via the matching network (5) to the transmitter subunit (2).

3. The antenna device as claimed in claim 1 or 2, characterised in that the first antenna element or elements (6) include a number of radiator elements which are mutually interconnectable and interconnectable to the matching network (5) in a number of alternative combinations.

4. The antenna device as claimed in any of claims 1 to 3, characterised in that said means for radiating and receiving radio waves includes two or more antenna elements connected to the receiver subunit (3) of the transceiver unit (1).

5. The antenna device as claimed in any of claims 1 to 4, characterised in that said means for radiating and receiving radio waves includes a second active matching network connected between the second antenna element or elements (8) and the receiver subunit (3) of the transceiver unit (1).

6. The antenna device as claimed in any of claims 1 to 5, characterised in that the first and second antenna elements (6; 8) are supplied via separate feeding lines (4 and 7, respectively).

7. The antenna device as claimed in any of claims 1 to 6, characterised in that the first antenna element or elements (6) is/are located at the upper end of the mobile telephone while the second antenna element or elements (8) is/are located at the lower end thereof, or vice versa.
